(19) United States
(12) Patent Application Publication
(10) Pub. No.: US 2025/0003257 A1
(43) Pub. Date: Jan. 2, 2025

(54) LOCK/UNLOCK INDICATOR

(71) Applicant: dormakaba USA, Inc., Indianapolis, IN (US)

(72) Inventors: Jamison D. Woodley, Indianapolis, IN (US); Daniel Langenberg, Zionsville, IN (US); Edward Horst, Indianapolis, IN (US)

(21) Appl. No.: 18/694,359

(22) PCT Filed: Sep. 23, 2022
(86) PCT No.: PCT/US2022/044542

§ 371 Date: Mar. 21, 2024

Related U.S. Application Data
(60) Provisional application No. 63/261,633, filed on Sep. 24, 2021.

(51) Int. Cl. E05B 41/00; E05B 17/10

(52) U.S. Cl. CPC E05B 41/00; E05B 17/10

(57) ABSTRACT

A visual indicator of lock status is disclosed. The visual indicator may include a locked indica and an unlocked indica. The locked indica and the unlocked indica may be selectively covered by an LCD shutter. The locked indica and the unlocked indica may be selectively viewable through a window due to a lateral translation.

### RELATED APPLICATIONS

This application claims the benefit of U.S. Provisional Patent Application No. 63/261,633 filed Sep. 24, 2021, titled “LOCK/UNLOCK INDICATOR,” the entire disclosure of which is expressly incorporated by reference herein.

### FIELD

The present disclosure relates to locking devices and, in particular, to door locks having a visual indicator of lock/unlock status.

### BACKGROUND

Locking devices are used in a variety of implementations to limit access to a space. For example, door locks can be used to limit one or both of ingress and egress through a door. In certain instances “exit doors” are employed. Exit doors never limit egress, but can have a locked condition that limits ingress. In a number of situations it is helpful to supply a visual indicator indicating the lock/unlock status of a lock. For example, a visual indicator on an exit door will signal to an occupant of the space enclosed by the exit door that ingress into the space currently is prohibited to those not having an appropriate key (physical or virtual).

### SUMMARY

In certain exemplary embodiments thereof, the present disclosure provides a visual indicator of lock status.

The disclosure, in one form thereof, provides a locking assembly, including: a locking device having a locked condition and an unlocked condition; a lock/unlock indicator, comprising: a bottom lamella having visual lock and unlock indicators; and a top lamella operable to selectively block visualization of the lock indicator while allowing visualization of the unlock indicator or to block visualization of the unlock indicator while allowing visualization of the lock indicator.

In one example thereof, a voltage delivered to the top lamella is configured to control whether the top lamella blocks visualization of the lock indicator while allowing visualization of the unlock indicator or to block visualization of the unlock indicator while allowing visualization of the lock indicator.

In another example thereof, the top lamella is composed of a first portion configured to either allow or block visualization of the unlock indicator and a second portion configured to allow for block visualization of the lock indicator.

In a further example thereof, when voltage is delivered to the first portion, the first portion blocks visualization of the unlocked indicator and when voltage is delivered to the second portion, the second portion blocks visualization of the lock indicator.

In another example thereof, the top lamella is actuated by at least one switch to selectively block of visualization of the lock indicator while allowing visualization of the unlock indicator or to block visualization of the unlock indicator while allowing visualization of the lock indicator.

In yet another example thereof, a controller actuates the at least one switch based on an input provided to the controller.

In another example thereof, an opacity of the top lamella determines whether the top lamella blocks visualization of the lock indicator while allowing visualization of the unlock indicator or blocks visualization of the unlock indicator while allowing visualization of the lock indicator.

In a further example thereof, the locking device includes an outer housing defining a groove extending at least partially therethrough, and wherein the lock/unlock indicator is received within the groove of the outer housing.

In another exemplary embodiment of the present disclosure, a method of indicating a locked condition or an unlocked condition of a locking device through the use of a lock/unlock indicator, the lock/unlock indicator comprising a bottom lamella having visual lock and unlock indicators and a top lamella arranged onto the bottom lamella, the top lamella having a first portion and a second portion, is provided. The method includes selectively displaying one of the visual lock and unlock indicators based on altering a voltage value delivered to the lock/unlock indicator.

In a further example thereof, selectively displaying one of the visual lock and unlock indicators further includes receiving an input to place the locking device in the locked condition or the unlocked condition, transferring the input to a controller, actuating at least one switch coupled with the top lamella to deliver a voltage to at least one of the first portion and the second portion of the top lamella, and visualizing one of the unlock indicator and the lock indicator.

In an example thereof, when the input places the locking device in the locked condition, voltage is delivered to the second portion of the top lamella and voltage is not delivered to the first portion of the top lamella, such that the lock indicator is visualized.

In yet another example thereof, when the input places the locking device in the unlocked condition, voltage is not delivered to the second portion of the top lamella and voltage is delivered to the first portion of the top lamella, such that the unlock indicator is visualized.

In a further example thereof, actuating the at least one switch coupled with the top lamella to deliver a voltage to at least one of the first portion and the second portion of the top lamella includes altering opacity of the at least one of the first portion and the second portion.

In yet another example thereof, the at least one switch is coupled with a power supply such that actuation of the at least one switch allowed for voltage delivery to the top lamella.

In a further example thereof, the at least one switch includes a first switch coupled with the first portion and a second switch coupled with the second portion and each of the first switch and the second switch are coupled with the power supply.

In another exemplary embodiment of the present disclosure, a method of indicating a locked condition or an unlocked condition of a locking device through the use of a lock/unlock indicator includes providing the lock/unlock indicator with a lock indica and an unlock indica permanently displayed on the lock/unlock indicator and selectively displaying the lock indica and the unlock indica through lateral translation of the lock/unlock indicator to cause one of the lock indica and the unlock indica to be displayed through a window of the locking device.

In an example thereof, selectively displaying the lock indica and the unlock indica includes first receiving an actuation to place the locking device into the locked condition or the unlocked condition to cause the lateral translation of the lock/unlock indicator.

### BRIEF DESCRIPTION OF THE DRAWINGS

The above-mentioned and other features and advantages of this disclosure, and the manner of attaining them, will become more apparent and will be better understood by reference to the following description of exemplary embodiments taken in conjunction with the accompanying drawings, wherein:

FIG. 1 is a front view of a locking device;

FIG. 1A is an alternative, partial front view of the locking device shown in FIG. 1;

FIG. 2 is a side elevational view of the locking device of FIG. 1, shown together, schematically, with an exit door and an exterior latch actuator;

FIG. 3 is a rear view of the locking device of FIG. 1;

FIG. 4 is a partial, rear view of the locking device of FIG. 1;

FIG. 5 is a partial, rear elevational view of the locking device of FIG. 1 showing a lock moveable between a locked position and an unlocked position, in the locked position the lock blocking actuation of a latch by a latch actuator, in the unlocked position the lock allowing actuation of the latch by the latch actuator;

FIG. 6 is a front perspective view of the locking device of FIG. 1 with the escutcheon removed;

FIG. 7 is a side perspective view of the locking device components illustrated in FIG. 6;

FIG. 8 is a partial, side perspective view showing the indicator assembly of the locking device of FIG. 1 in accordance with an embodiment of the present disclosure;

FIG. 9 is a partial, rear perspective of the locking device of FIG. 1;

FIG. 10 is a partial, side perspective view illustrating, among other things, an indicator assembly in accordance with an embodiment of the present disclosure;

FIG. 11 is a partial, rear view of, among other things, the indicator assembly of FIG. 10;

FIG. 12 is a partial, side elevational view of, among other things, the indicator assembly of FIG. 10;

FIG. 13 is a partial, perspective view of, among other things, the indicator assembly of FIG. 10;

FIG. 13A is a partial, perspective view of, among other things, the indicator assembly of FIG. 10;

FIG. 14 is a rear perspective view of the indicator assembly shown with other elements of the blocking device of FIG. 10;

FIG. 15 is a front perspective view of the indicator assembly of FIG. 14;

FIG. 16 is a schematic illustration of an alternative locking assembly of the present disclosure;

FIG. 17 is a schematic illustration of a lock/unlock indicator of the present disclosure;

FIGS. 18 and 19 are schematic illustrations of the lock/unlock indicator of FIG. 17 showing the lock and unlock appearance thereof, respectively;

FIG. 20 is a block diagram of an LCD shutter/switch/power source combination;

FIG. 21 is an exemplary locking assembly; and

FIG. 22 is an exploded view of the locking assembly of FIG. 21.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

For the purposes of promoting an understanding of the principles of the present disclosure, reference is now made to the embodiments illustrated in the drawings, which are described below. The embodiments disclosed herein are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

In some instances throughout this disclosure and in the claims, numeric terminology, such as first, second, third, and fourth, is used in reference to various components or features. Such use is not intended to denote an ordering of the components or features. Rather, numeric terminology is used to assist the reader in identifying the component or features being referenced and should not be narrowly interpreted as providing a specific order of components or features.

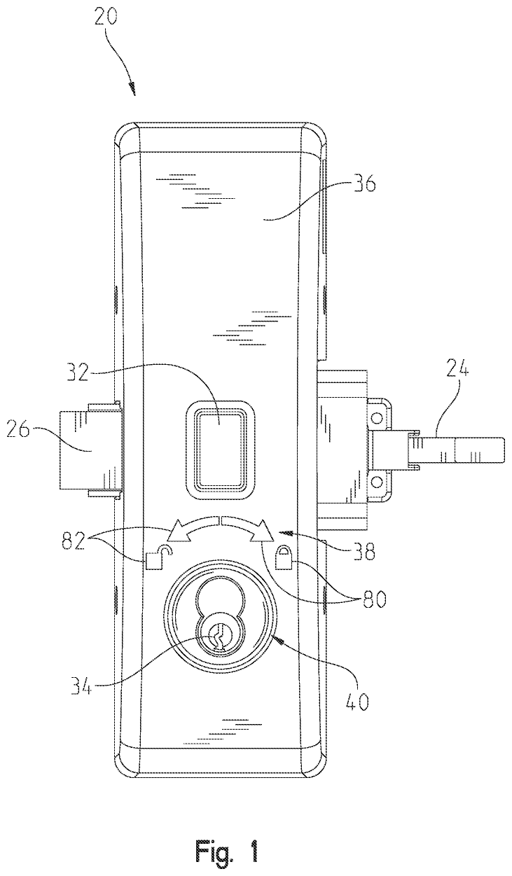

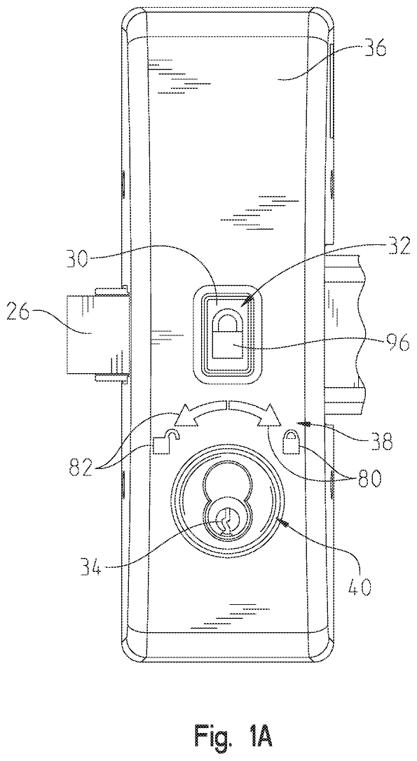

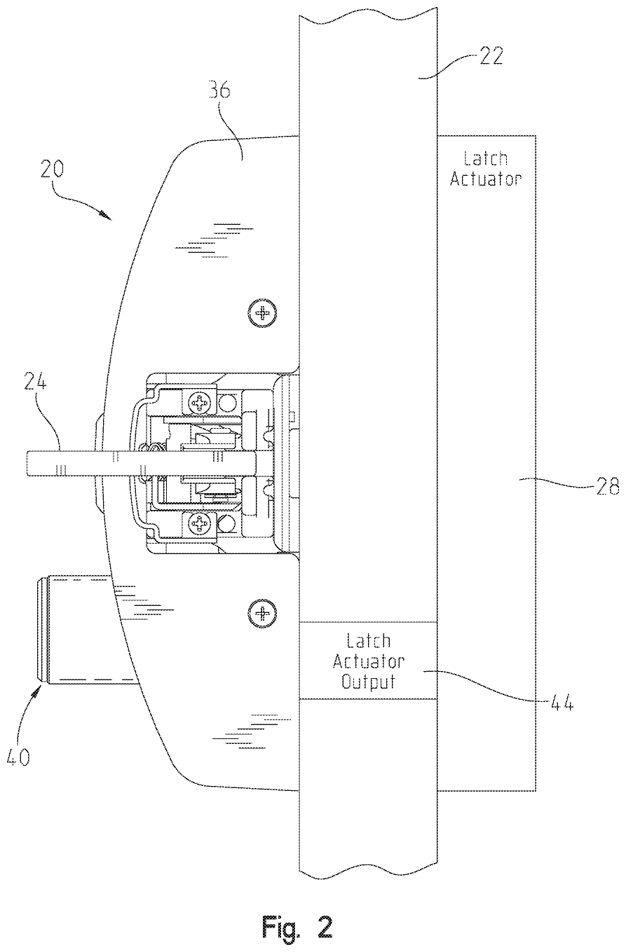

Referring to FIG. 1, locking device 20 is illustrated. Locking device 20 illustrated in the exemplary embodiments of the present disclosure is meant for use with exit door 22 (FIG. 2). Locking device 20 includes egress handle 24 which is always operable (i.e., cannot be locked) to actuate latch 26 and allow egress through exit door 22. Referring to FIG. 2, exit door 22 has exterior latch actuator 28 connected thereto. Exterior latch actuator 28 is selectively operable through latch actuator output 44 to actuate latch 26 to allow ingress through exit door 22. Numerous conventional mechanisms may be utilized to transmit input motion received by latch actuators such as egress handle 24 and exterior latch actuator 28 into actuation of a latch such as latch 26. In the simplest arrangement, a latch actuator may rotate a cam which pulls latch 26 out of engagement with the barrier against which latch 26 presses to provide locking. Exterior latch actuator 28 may take numerous forms, including, e.g., a handle, a thumb turn, or a knob.

Referring to FIG. 1A, locking device 20 includes visible indicator flag 30 visible through window 32. Visible indicator flag 30 forms a part of a visible indicator assembly operable to visibly indicate the locked or unlocked status of locking device 20. More particularly, visible indicator flag 30 signals whether locking device 20 maintains a locked position in which latch actuator 28 (FIG. 2) cannot be utilized to provide ingress through exit door 22. The indicator assembly of the present disclosure will be further described in the text that follows and is adaptable to a variety of locking devices including but not limited to the exit door lock shown herein. Window 32 provides protection to visible indicator flag 30, allowing visible indicator flag to be viewed, but not touched.

As described above, locking device 20 illustrated in the exemplary embodiments herein is useable for one-way locking of exit door 22. In the exemplary embodiments illustrated, such locking is effected by inserting a key into keyway 34 and rotating such key clockwise. Once these steps have been followed, locking device 20 will maintain a locked configuration in which latch actuator 28 is ineffective to actuate latch 26 to allow ingress through exit door 22. To unlock locking device 20, the key may again be positioned in keyway 34 and rotated counterclockwise to replace locking device 20 in an unlocked condition allowing latch actuator 28 to actuate latch 26 to allow ingress through door 22. To facilitate ease of operation, locking device 20 of the present disclosure features escutcheon 36 having operation indicator 38. Operation indicator 38 signals to an operator the input needed to effect locking or unlocking of locking device 20. In the exemplary embodiment shown, operation indicator 38 signals the rotation of a key properly inserted into keyway 34 needed to effect locking or unlocking of locking device 20.

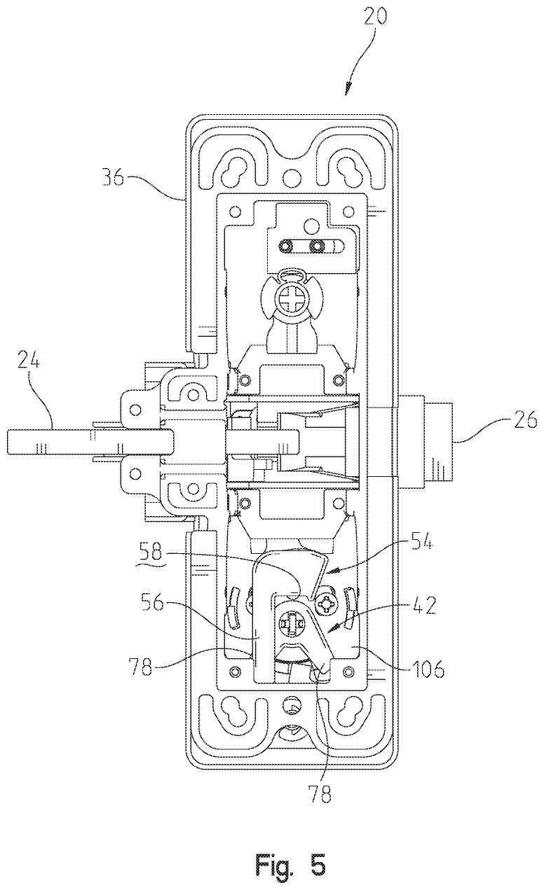

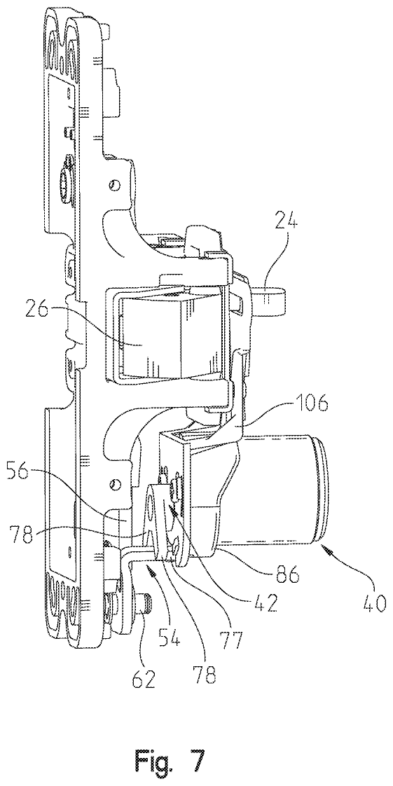

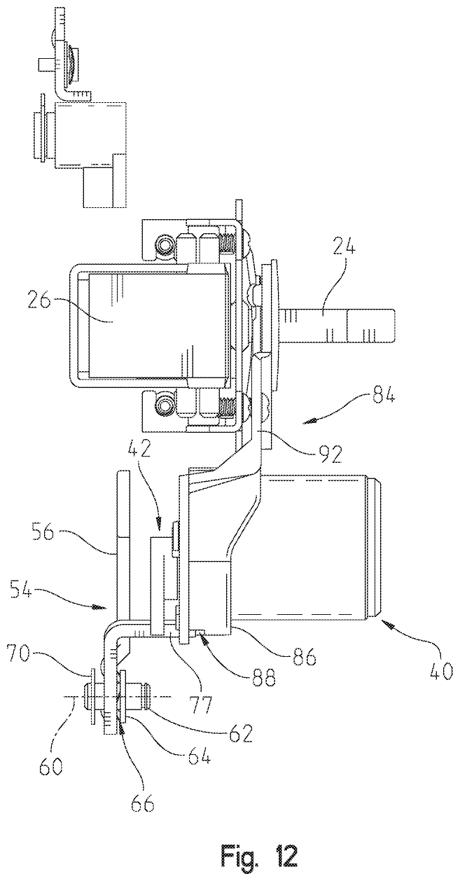

Locking device 20 includes lock core 40 having an input in the form of keyway 34 (and an associated key) and an output in the form of tailpiece 42 (see, e.g., FIGS. 5, 7, 8, and 10-14. Tailpiece 42 is actuated by input 34 to effect locking and unlocking of locking device 20, as will be further described hereinbelow. Input 34 is exemplified herein as a keyway (and an associated key). “Input” and keyway will be interchangeably used in this document with respect to element 34, with “input” being the more general term. When the input takes the form of a keyway, input motion will be received by a combination of a key and keyway 34. In alternative forms of the disclosure, input 34 may, e.g., take the form of a knob, a handle, or a thumb turn. Generally, input 34 is a device allowing (in some embodiments selectively allowing) input rotation to be communicated to tailpiece 42 to produce rotation of tailpiece 42.

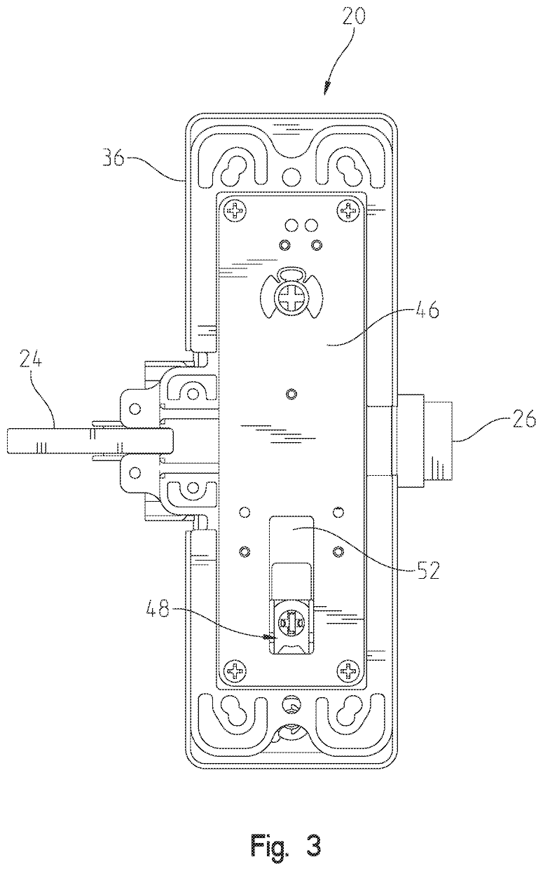

To effect movement of latch 26 to allow ingress through exit door 22, latch actuator 28 includes latch actuator output 44 as shown in FIG. 2. Latch actuator output 44 extends through baseplate 46 (FIG. 3) of locking device 20 to selectively actuate latch 26. More particularly, latch actuator output 44 is received into aperture 48 of baseplate 46 to enable movement of latch actuation mechanism 50 to effect movement of latch 46 into and out of locking position to prohibit ingress and egress through exit door 22. For the sake of brevity, latch actuation mechanism 50 will not be described in detail. Latch actuation mechanisms generally incorporate a physical input which effects movement of one or more components of the actuation mechanism to thereby effect actuation of the latch. With this in mind, locking of a latch actuator can be effected by precluding movement of an input to the mechanism, as is done in the exemplification illustrated herein.

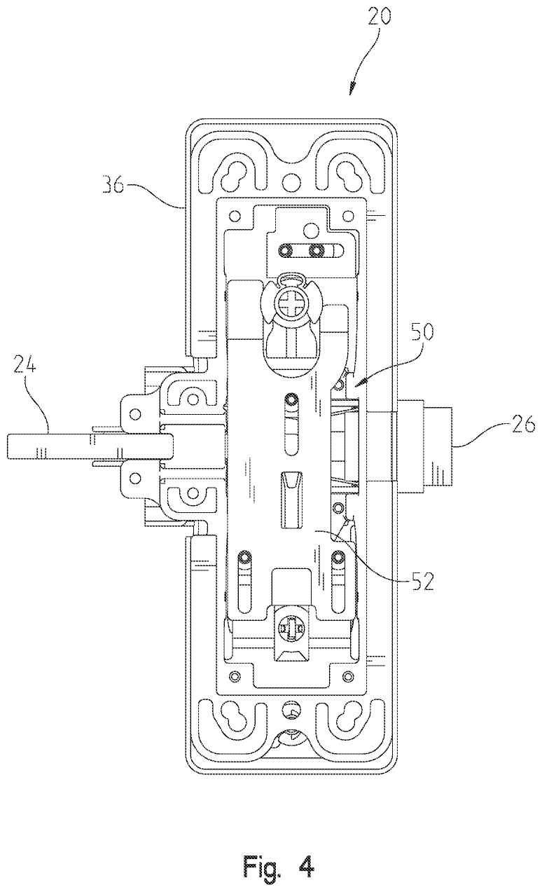

In the exemplification of the present disclosure illustrated, e.g., in FIGS. 3 and 4, latch actuator output 44 (FIG. 2) comprises a protrusion in the form of a rod having a substantially square cross-section received in aperture 48 (see, e.g., FIG. 3). Actuator output 44, in the form of a rod having a square cross-section may be moved vertically by latch actuator 28 (FIG. 2) to move sliding plate 52 of latch actuation mechanism 50 vertically which, through latch actuation mechanism 50, effects movement of latch 26 out of blocking engagement to allow opening of exit door 22. To effect locking of latch actuation mechanism 50 and preclude use of latch actuator 28 to actuator latch 26, lock 54 (FIGS. 5, 8, 11 and 13) can be positioned to present a physical barrier disallowing movement of latch actuator output 44 upward to translate sliding plate 52 and actuate latch actuation mechanism 50. Referring, e.g., to FIGS. 5-8, and 10-13, lock 54 includes locking arm 56 featuring barrier 58 operable to selectively resist upward movement of latch actuator output 44 to preclude latch actuator 28 from actuating latch 26.

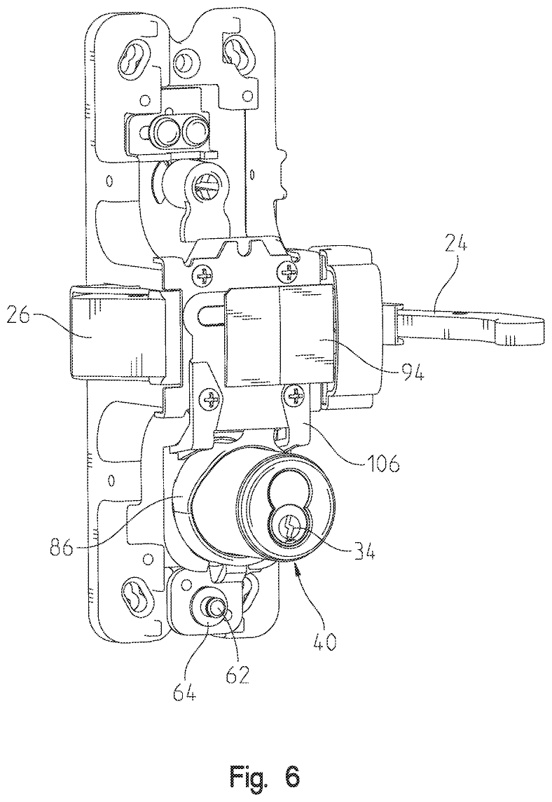

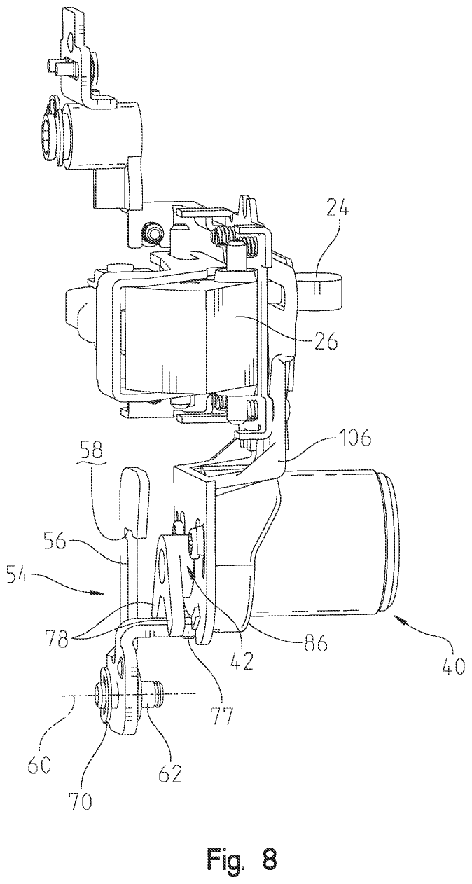

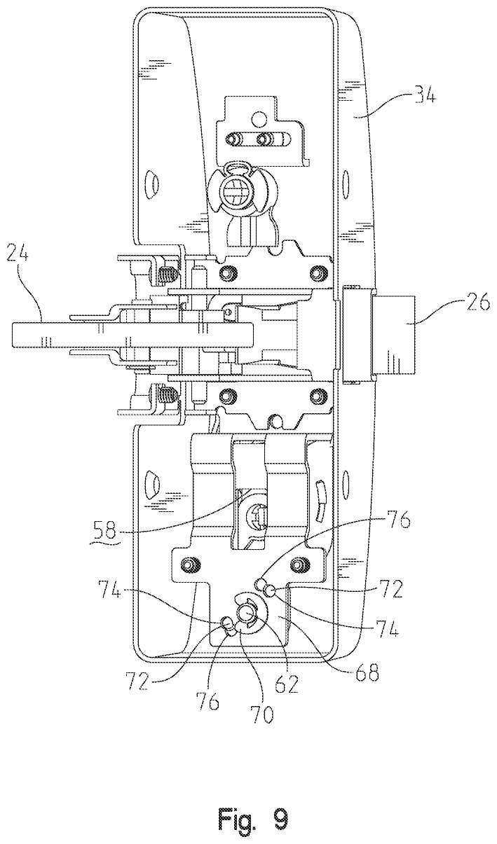

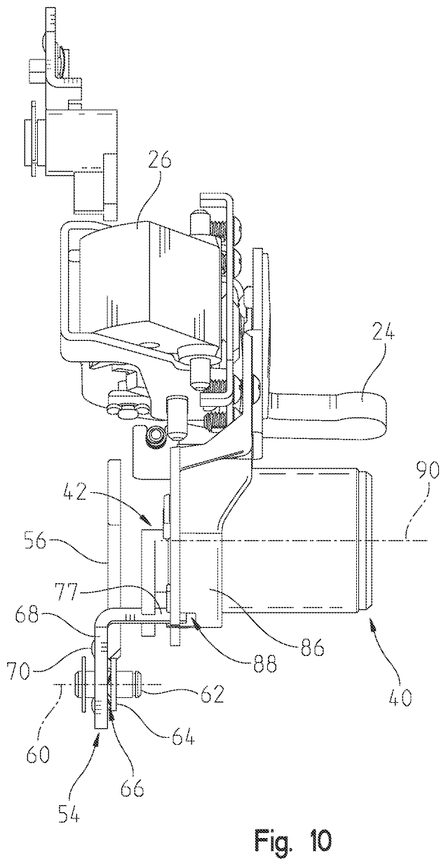

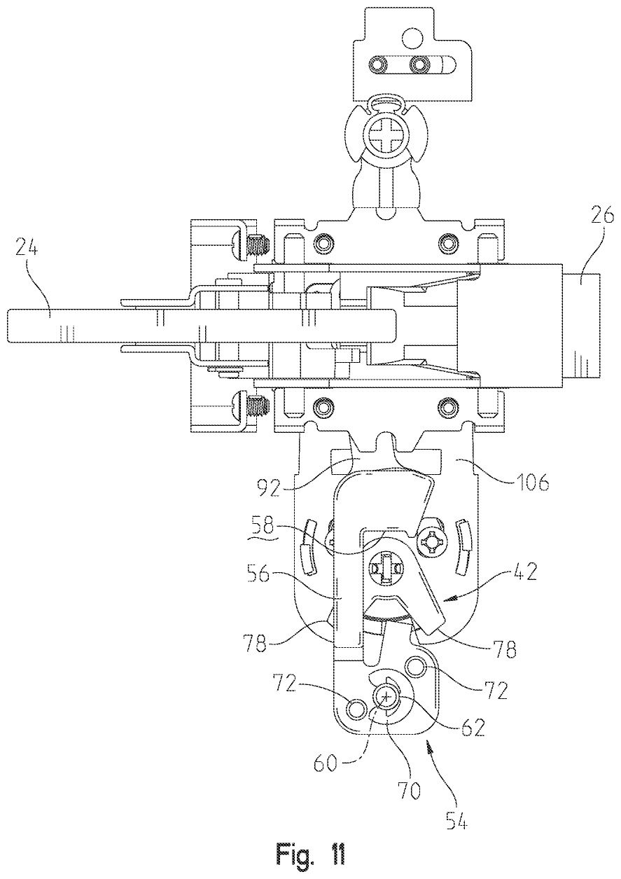

Appendix 1 attached to and forming a part of U.S. provisional patent application Ser. No. 62/868,889 filed Jun. 29, 2019 provides additional details of an exemplification of the present disclosure. The entire content of Appendix 1 is hereby explicitly incorporated by reference herein. Page 3 of the Appendix 1 illustrates locking arm 56 in both the locked and unlocked conditions. To effect movement of lock 54 (and, consequently, locking arm 56 and barrier 58), lock 54 is pivotable about pivot axis 60 (FIG. 8) of pivot pin 62. Pivot pin 62 extends through a circular aperture through lock 54 sized just slightly larger than the circular exterior of pivot pin 62 to allow lock 54 to pivot about pivot pin 62. Pivot pin 62 includes flange 64 (FIG. 6) extending radially therefrom. Underneath flange 64 and intermediate flange 64 and lock 54 is wave spring 66 (FIG. 10). In construction, pivot pin 62 is passed through wave spring 66 and the circular aperture in lock 54. From this position, pivot pin 62 can further be passed through a circular aperture through support plate 68 (see, e.g., FIGS. 9 and 10). In this position, snap ring 70 is secured to an annular groove formed in the distal end of pivot pin 62 to secure lock 54 in operable position. Referring to FIGS. 9 and 11, lock 54 includes protrusion 72 cooperating with apertures 74 to form a lock detent positioned to retain lock 54 in the locked position. From this position, lock 54 can be rotated about pivot axis 60 of pivot pin 62 to the unlocked position. In the unlocked position, protrusions 72 occupy apertures 76 to define an unlocked detent positioned to retain lock 54 in the unlocked position. These detents index and hold lock 54 in the lock and unlock positions, respectively. As illustrated in the figures, pivot axis 60 is spaced from the axis of rotation of tailpiece 42.

To allow rotation received by input 34 of lock core 40 to move lock 54 between the locked and locked positions described above, actuation arm 77 of lock 54 is positioned intermediate a pair of tailpiece arms 78 of tailpiece 42. Rotation of input 34 of lock core 40 causes rotation of tailpiece 42 in a conventional manner. With actuation arm 77 positioned between the pair of spaced tailpiece arms 78, rotation of tailpiece 42 via input 34 in a first rotational direction causes a first one of the pair of spaced tailpiece arms 78 to actuate actuation arm 77 and thereby position lock 54 in the lock position. Similarly, rotation of the tailpiece of the lock core via the input of the lock core in a second rotational direction opposite the first rotational direction causes a second one of the pair of spaced tailpiece arms 78 to actuate actuation arm 77 and thereby position lock 54 in the unlocked position.

Referring back to FIGS. 1 and 1A, the first rotation direction referenced in the preceding paragraph is the clockwise direction while the second rotational direction is the counterclockwise direction. These directions are signaled by operation indicator 38. Operation indicator 38 signals to an operator a lock operator input direction for operating input 34 of lock core 40 to place lock 54 in the lock position and also signals to the operator an unlocked operator input direction for operating input 34 of lock core 40 to place lock 54 in the unlocked position. The particular embodiment of operation indicator 38 exemplified herein includes a debossed area including locked debossed area 80 and unlocked debossed area 82.

Escutcheon 36 is formed of sheet metal. In the process of forming Escutcheon 36, the sheet metal is deep drawn into the shape illustrated herein. After this process step, operation indicator 38 can be formed by stamping locked debossed area 80 and unlocked debossed area 82 into the front surface of the sheet metal. After stamping locked debossed area 80, locked debossed area 80 is filled with a red enamel paint. After stamping unlocked debossed area 82, unlocked debossed area 82 is filled with a green enamel paint. When the red enamel paint which visually indicates a locked condition and the green enamel paint which visually indicates an unlocked condition has dried, a clear coat is applied to the exterior of the escutcheon 36 and the dried paint. In one exemplary embodiment Micro Guard® AD1000 is utilized as the clearcoat. This clearcoat covalently bonds to the surface of Escutcheon 36 to provide a high level of protection and a high degree of wearability to operation indicator 38. Micro Guard® AD1000 is further described in the spec sheet relating to the same attached as Appendix 2 to and forming a part of U.S. provisional patent application Ser. No. 62/868,889 filed Jun. 29, 2019, the entire disclosure of Appendix 2 of U.S. provisional patent application Ser. No. 62/868,889 is hereby explicitly incorporated by reference herein.

While operation indicator 38 signals to an operator inputs needed to achieve the locked or unlocked state, visible indicator 84 selectively indicates the lock position of lock 54 and the unlock position of lock 54. Stated another way, operation indicator 38 shows the user how to lock and unlock locking device 20, while visible indicator 84 displays the current condition of locking device 20, i.e., locked or unlocked.

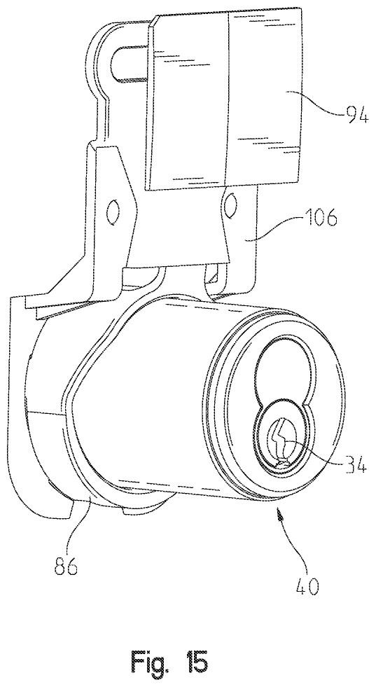

Referring to the figures, and particularly, FIGS. 6-15, visible indicator 84 includes cuff 86 positioned about an exterior of lock core 40. The exterior of lock core 40 will, in certain embodiments of the present disclosure, take the form of a shell housing an interchangeable lock core such as a small format interchangeable core (SFIC) as shown in the illustrations. Additional details of SFICs can be found in U.S. patent application Ser. No. 16/846,098, the entire disclosure of which is hereby explicitly incorporated by reference herein. Cuff 86 comprises a cylinder with a central opening therethrough. Cuff 86 is shaped and sized to fit about and rotate relative to the exterior surface of lock core 40. Referring, e.g., to FIG. 10, cuff 86 includes cutout 88 sized to accommodate actuation arm 77 positioned therein. As will be described in further detail below, actuation arm 77 is operable to effect displacement of visible indicator 84 and therefore is alternatively termed visible indicator actuator 77 throughout this document. As tailpiece 42 is rotated, visible indicator actuator 77 is rotated, as described above in connection with actuation of lock 54. Rotation of visible indicator actuator 77 causes rotation of cuff 86 about longitudinal axis 90 of lock core 40. As illustrated, extending from cuff 86, is indicator arm 92. In certain embodiments of the present disclosure, cuff 86 and indicator arm 92 comprise a single piece, as opposed to multiple discreet pieces joined one to the other. The single piece construct of cuff 86 and indicator arm may be described as “monolithic,” or “integral.” Monolithic and integral in this context are both used to denote a single, continuous material.

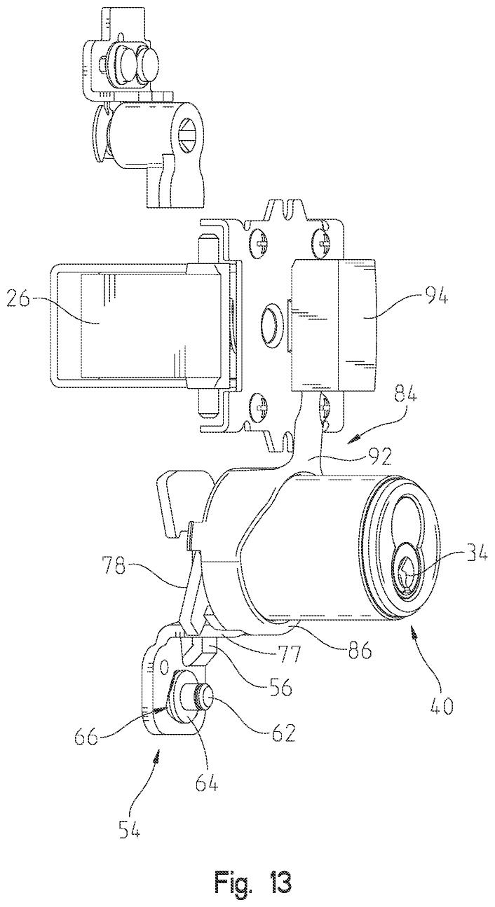

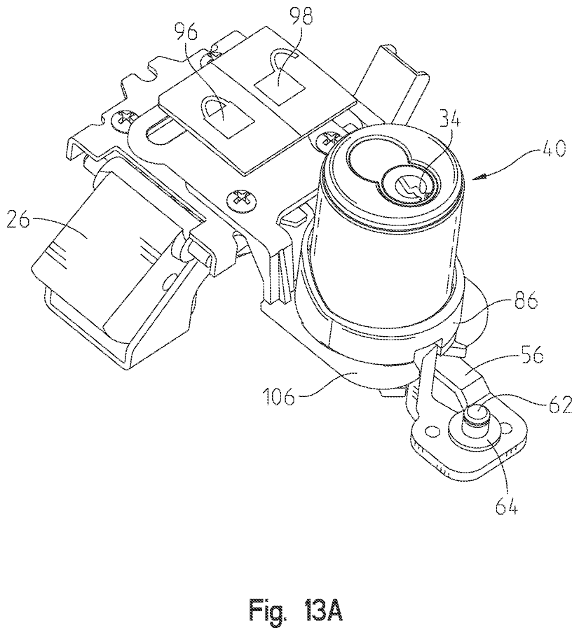

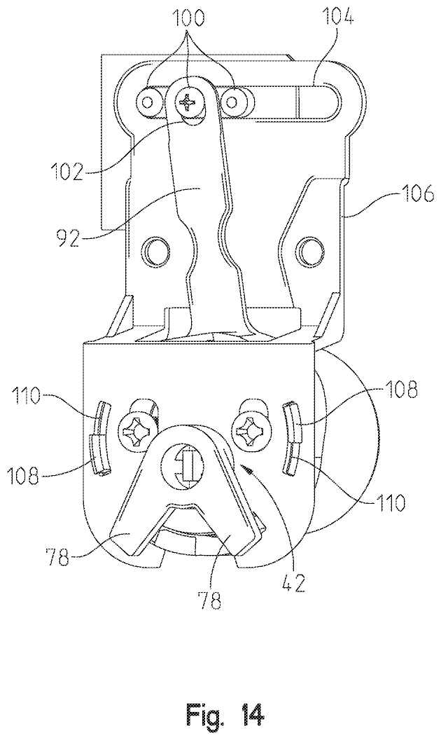

In the exemplification illustrated, indicator arm 92 extends substantially (i.e., within usual tolerances) radially from the longitudinal axis of cuff 86, which coincides with longitudinal axis 90 (of lock core 4) when visible indicator 84 is operably assembled on lock core 40. In alternative forms of the present disclosure, indicator arm 92 may extend transversely from the longitudinal axis of cuff 86, but not radially (radially being a more narrow form of “transverse”). At the end of indicator arm 92 opposite cuff 86 is flag carrier 94. Flag carrier 94 features lock visible indicator 96 and unlock visible indicator 98 (FIG. 13A). As seen most clearly in FIG. 14, flag carrier 94 includes three bosses 100 extending rearwardly therefrom. A first of these bosses is positioned through slot 102 of indicator arm 92. All three bosses are positioned in slot 104 of visible indicator support plate 106 to form a guide guiding linear movement of flag carrier 94. As cuff 86 is rotated by tailpiece 42, rotary motion of indicator arm 92 is translated into linear motion of flag carrier 94 owing to the positioning of bosses 100 in slot 104. Importantly, visible indicator 94 is actuated by lock 54, thereby ensuring that an accurate representation of the locked or unlocked condition of locking device 20 is indicated. In the locked condition, lock visible indicator 96 is positioned under window 32 and is visible therethrough while unlock visible indicator 98 is obscured from view. Similarly, in the unlocked condition of locking device 20, unlocked visible indicator 98 is positioned beneath window 32 and is visible therethrough, while lock visible indicator 96 is obscured from view.

Motion of visible indicator 84 is guided by the positioning of cuff 86 about the exterior of lock core 40. Further, protrusions 108 ride in arcuate slots 110 of visible indicator support plate 106. Cooperation of protrusions 108 and accurate slots 110 further limits the extent of rotation of cuff 86 about lock core 40.

In the exemplification described herein, tailpiece 42 transmits rotary motion from input 34 of lock core 40 through tailpiece 42 to lock 54 (including actuation arm 77 thereof) in a motion transfer stream, tailpiece 42 being downstream from input 34 in the motion transfer stream and lock 54 being downstream from tailpiece 42 in the motion transfer stream. Importantly, the method of actuating visible indicator 84 comprises the step of actuating visible indicator 84 downstream from lock 54 in the motion transfer stream. In this way, movement in the motion transfer stream upstream of lock 54 is ineffective to actuate visible indicator 84 and therefore false flags cannot be given. Stated another way, if the lock was experiencing failure such as the transmission stream stopped short of lock 54, actuation of lock core 40 would not cause actuation of visible indicator 84, thereby avoiding a false flag.

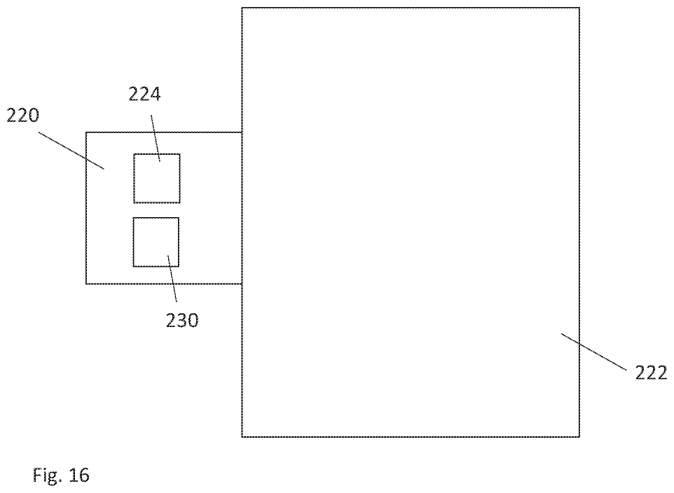

FIG. 16 schematically illustrates alternative locking device 220. Locking device 220 is operable to selectively lock and unlock barrier 222. When locked, barrier 222 is operable to block access to a space enclosed by barrier 222. For example, barrier 222 may be a door operable to selectively enclose a room or storage compartment. Locking device 220 may, in certain exemplifications thereof, be exemplified as exit device 20 adapted to feature the alternative visible indicator assembly described below. In alternative embodiments, locking device 220 may feature a latch bolt positionable to block movement of barrier 222 in a locked condition of locking device 220 and further positionable to allow movement of barrier in an unlocked condition.

Locking device 220 includes actuator 224 operable to receive an operator input (e.g., in the form of a physical input such as rotary or linear input motion delivered to a key, button, or knob, for example, or an electronic input such as a credential causing electronic actuation of locking device 220) to place locking device 220 in a locked or unlocked condition. Locking device 220 includes a housing e.g., for internal components such as escutcheon 36, or a rose used with a rotary knob or handle. The locking device housing will allow visual access to a lock/unlock indicator 230. In an exemplification of the present disclosure, the locking device housing will include a window, e.g., window 32 of escutcheon 36.

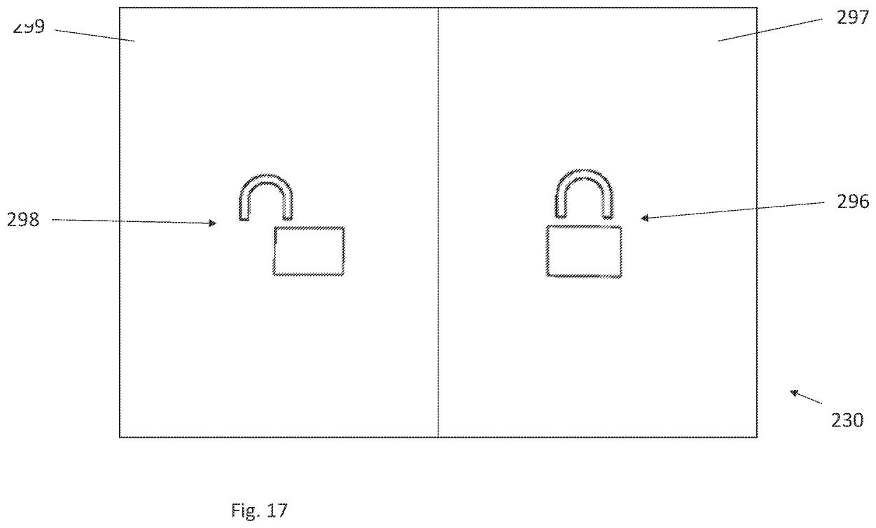

FIG. 17 schematically illustrates lock/unlock indicator 230, which may be used in place of visible indicator flag 30 described above. Lock/unlock indicator 230 includes lock visible indicator 296 and unlock visible indicator 298. In the exemplification illustrated, lock visible indicator 296 occupies lock indicator area 297 of lock/unlock indicator 230, while unlock visible indicator 298 similarly occupies unlock indicator area 299. In exemplary embodiments, lock/unlock indicator 230 will be visible through a housing of locking device 220. For example, if locking device 220 features an escutcheon, similar to escutcheon 36 described above, then the window 32 through escutcheon 36 will be large enough to allow viewing of both lock indicator area 297 and unlock indicator area 299 simultaneously.

Lock/unlock indicator 230 is positioned, in use, such that both lock indicator area 297 and unlock indicator area 299 are simultaneously viewable, but for an LCD shutter. More particularly, lock/unlock indicator 230 comprises a bottom lamella featuring both lock indicator area 297 (with lock visible indicator 296) and unlock indicator area 299 (with unlock visible indicator 298) as visual indicators with a top lamella in the form of an LCD (liquid crystal display) shutter positioned atop the bottom lamella. For example, the bottom lamella of lock/unlock indicator 230 may feature a green unlock indicator area 299 with a white unlock visible indicator 298 and a red lock indicator area 297 with a white lock visible indicator 296. The top lamella of lock/unlock indicator 230 extends over the entirety of lock indicator area 297 and unlock indicator area 299 and features a lock LCD shutter and an unlock LCD shutter. The lock LCD shutter covers lock indicator area 297 and the unlock LCD shutter covers the unlock indicator area 299. Both the lock LCD shutter and the unlock LCD shutter comprise liquid crystal light valves having varying opacity from nearly 100% opaque (e.g., 95% opaque) to nearly transparent (e.g., 5% opaque). 100% opaque signals blockage of all light, while 0% opaque signals blockage of no light by the LCD shutter.

Opacity of each LCD shutter is independently varied by voltage applied to each of the LCD shutters. When a voltage of, e.g., 4 volts DC is applied to either the lock LCD shutter or the unlock LCD shutter, the LCD shutter receiving such voltage becomes nearly 100% opaque and substantially blocks viewing of the indicator beneath. Voltage can be applied to the LCD shutters through a controller associated with locking device 220 or through a switch actuated by actuator 224. Similarly, voltage can be driven with a zero volt signal or a draining resistor can be implemented to render either LCD shutter nearly transparent, with a controller and/or a system of switches triggered by actuator 224.

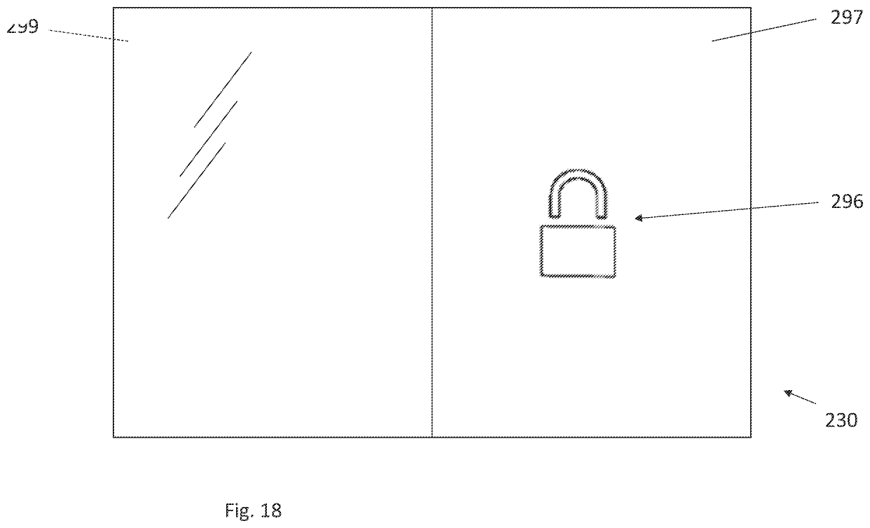

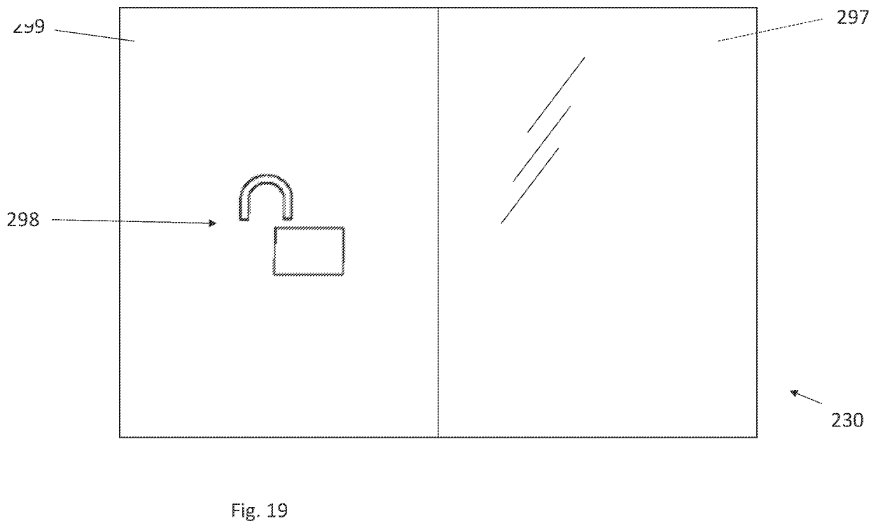

With actuator 224 actuated to place locking device 220 in a locked condition, voltage is applied to the top lamella to provide lock/unlock indicator 230 with the appearance shown in FIG. 18. Similarly, with actuator 224 actuated to place locking device 220 in an unlocked condition, voltage is applied to the top lamella to provide lock/unlock indicator 230 with the appearance shown in FIG. 19.

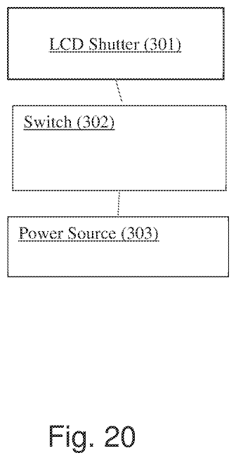

FIG. 20 illustrates an exemplary LCD Shutter 301, which can include any number of a plurality of technologies that operate by varying its transparency based on an electric voltage, including TFT, FSTN, STN, TN, and E-Ink technologies. The LCD shutter is activated by a mechanical or electrical switch 302, which can be as simple as a Single Pole Double Throw switch up through a microcontroller with discrete transistors to vary the speeds. The amount of transparency and opacity can be controlled based on the Power Source, which can be directly fed from a power source 303, such as a battery, or, through a power conditioning circuit that regulates the power to appropriate voltage levels.

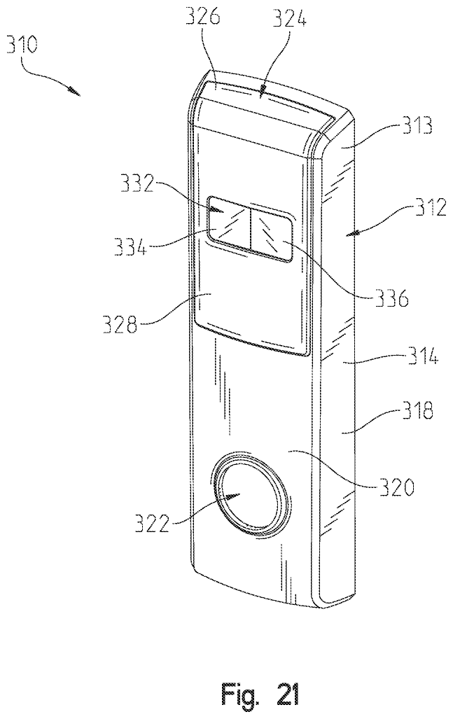

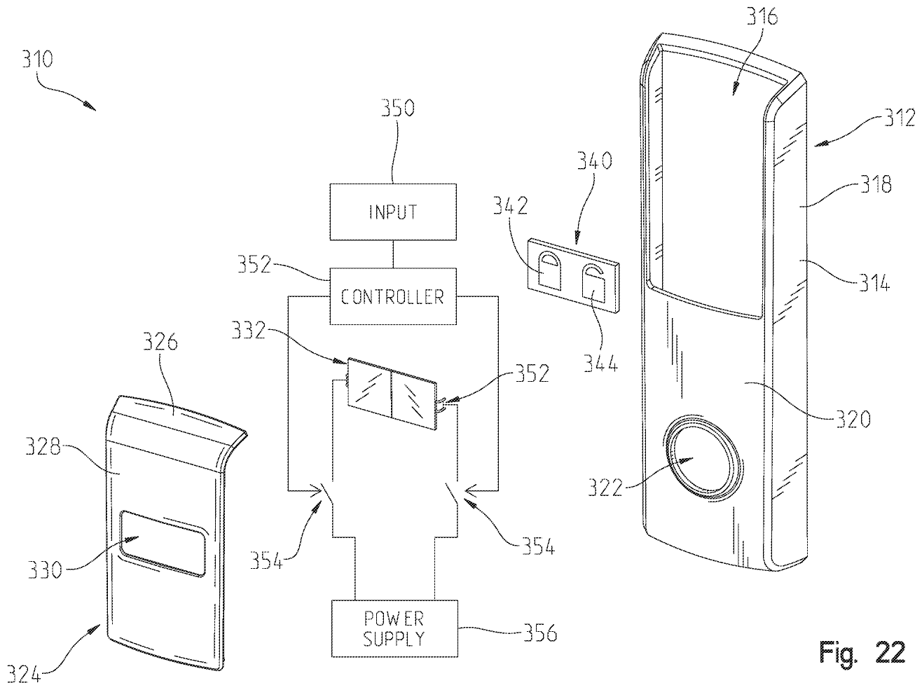

FIGS. 21 and 22 illustrate an exemplary embodiment of a locking assembly 310 incorporating a locking indicator similar to as described in FIGS. 16-20. For example, locking assembly 310 includes a locking device 312 having an outer body 314 defined by a generally rectangular shape. As illustrated, outer body 314 comprises a back plate 318 and a front plate 320 connected with one another through side walls 313 extending around an entirety of outer body 314. Front plate 320 additionally includes a circular opening 322 which may be configured for receiving lock core 40 (FIG. 1) or various other actuation means for controlling the locked or unlocked condition of locking device 312.

Further, front plate 320 and at least a portion of side walls 313 include a cut out defining a groove 316 extending within locking device 312 of locking assembly 310. Groove 316 is configured for receiving a cover plate 324 therein. Plate 234 includes a first, generally flat portion 328 and a second, generally curved portion 326 which are configured for engagement with groove 316 of outer body 314. As illustrated best in the exploded view of FIG. 21, flat portion 328 includes a rectangular opening 330 which may be provide for visualization of an LCD shutter and indicator plate, illustratively LCD shutter 332 and indicator plate 340, received within groove 316 which define an unlock/lock indicator. As previously described herein, LCD shutter 332 may be referred to herein as a top lamella while indicator plate 340 may be referred to herein as a bottom lamella. In embodiments, LCD shutter 332 is arranged onto indicator plate 340.

Further, as illustrated best in FIG. 22, indicator plate 340 includes a lock visible indicator 342 and an unlock visible indicator 344. Further, LCD shutter 332 includes a first portion 334 configured to cover lock visible indicator 342 and a second portion 336 configured to cover unlock visible indicator 344. First portion 336 may be the same as or similar to lock LCD shutter described with reference to FIGS. 17-20 and second portion 336 may be the same as or similar to unlock LCD shutter described with reference to FIGS. 17-20.

Similar to as described with reference to locking indicator 230 of FIGS. 17-20, lock visible indicator 342 and unlock visible indicator 344 are positioned such that both lock visible indicator 342 and unlock visible indicator 344 are simultaneously viewable, but for LCD shutter 332. LCD shutter 332 may be similar to, or the same as, the LCD shutter of FIGS. 17-20, such that LCD shutter 332 is varied by voltage applied to LCD shutter to affect the opacity of LCD shutter 332 and control which of lock visible indicator 342 and unlock visible indicator 344 are visible through LCD shutter 332 and thus to an operator, based on the unlocked or locked status of locking device 312.

For example, and with reference still to FIG. 21, an input 350 is received and places locking device 310 into the locked or unlocked condition. Based on input 350, a controller 352 may cause actuation of at least one electrical switch. For example, at least one electrical switch 354 is coupled with the first portion 332 and at least one electrical switch 354 is coupled with second portion 334. Based on actuation from controller 352, electrical switches 354 may either inhibit or allow voltage to be delivered to first portion 334 and second portion 336 from a power supply 356, which is electrically coupled with electrical switches 354. Power supply 356 may be a battery, a power conditioning circuit that regulates the power to appropriate voltage levels, or various other applicable voltage power sources.

For example, if input 350 places locking device 312 into the unlocked condition, controller 352 may cause actuation of electrical switches 354 such that voltage is delivered to the first portion 334 to cause the opacity of first portion 334 to be approximately 100% and inhibit visualization of lock visual indicator 342. In these instances, and as described with reference to the LCD shutter of FIGS. 17-19, a voltage of approximately 4 volts DC may be applied to first portion 332 to cause the opacity to be approximately 100%. However, various other voltage values may be sufficient for causing first portion 334 (or second portion 336) to have opacity of approximately 100%. Further, in these instances, controller 352 may not actuate the at least one electrical switch 356 coupled with second portion 336 or may cause zero voltage to be delivered to second portion 336, such that the opacity of second portion 336 is approximately 0% allowing visualization of unlock visual indicator 344.

In the embodiments wherein input 350 causes locking device 310 to be in the locked condition, controller 352 may actuate the at least one electrical switch coupled with second portion 336 to cause voltage to be delivered to second portion 336 and cause the opacity to be approximately 100%, while inhibiting the voltage delivery to first portion 334 to cause the opacity of first portion 336 to be approximately 0%, allowing the visualization of lock visible indicator 342.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A locking assembly, comprising:
a locking device having a locked condition and an unlocked condition;
a lock/unlock indicator, comprising:
a bottom lamella having visual lock and unlock indicators; and
a top lamella operable to selectively block visualization of the lock indicator while allowing visualization of the unlock indicator or to block visualization of the unlock indicator while allowing visualization of the lock indicator.

2. The blocking assembly of claim 1, wherein a voltage delivered to the top lamella is configured to control whether the top lamella blocks visualization of the lock indicator while allowing visualization of the unlock indicator or to block visualization of the unlock indicator while allowing visualization of the lock indicator.

3. The locking assembly of claim 1, wherein the top lamella is composed of a first portion configured to either allow or block visualization of the unlock indicator and a second portion configured to allow for block visualization of the lock indicator.

4. The locking assembly of claim 3, wherein when voltage is delivered to the first portion, the first portion blocks visualization of the unlocked indicator and when voltage is delivered to the second portion, the second portion blocks visualization of the lock indicator.

5. The locking assembly of claim 1, wherein the top lamella is actuated by at least one switch to selectively block of visualization of the lock indicator while allowing visualization of the unlock indicator or to block visualization of the unlock indicator while allowing visualization of the lock indicator.

6. The locking assembly of claim 5, wherein a controller actuates the at least one switch based on an input provided to the controller.

7. The locking assembly of claim 1, wherein an opacity of the top lamella determines whether the top lamella blocks visualization of the lock indicator while allowing visualization of the unlock indicator or blocks visualization of the unlock indicator while allowing visualization of the lock indicator.

8. The locking assembly of claim 1, wherein the locking device includes an outer housing defining a groove extending at least partially therethrough, and wherein the lock/unlock indicator is received within the groove of the outer housing.

9. A method of indicating a locked condition or an unlocked condition of a locking device through the use of a lock/unlock indicator, the lock/unlock indicator comprising a bottom lamella having visual lock and unlock indicators and a top lamella arranged onto the bottom lamella, the top lamella having a first portion and a second portion, the method comprising:
selectively displaying one of the visual lock and unlock indicators based on altering a voltage value delivered to the lock/unlock indicator.

10. The method of claim 9, wherein selectively displaying one of the visual lock and unlock indicators further comprises:
receiving an input to place the locking device in the locked condition or the unlocked condition;
transferring the input to a controller;
actuating at least one switch coupled with the top lamella to deliver a voltage to at least one of the first portion and the second portion of the top lamella; and
visualizing one of the unlock indicator and the lock indicator.

11. The method of claim 10, wherein when the input places the locking device in the locked condition, voltage is delivered to the second portion of the top lamella and voltage is not delivered to the first portion of the top lamella, such that the lock indicator is visualized.

12. The method of claim 10, wherein when the input places the locking device in the unlocked condition, voltage is not delivered to the second portion of the top lamella and voltage is delivered to the first portion of the top lamella, such that the unlock indicator is visualized.

13. The method of claim 12, wherein actuating the at least one switch coupled with the top lamella to deliver a voltage to at least one of the first portion and the second portion of the top lamella includes altering opacity of the at least one of the first portion and the second portion.

14. The method of claim 12, wherein the at least one switch is coupled with a power supply such that actuation of the at least one switch allowed for voltage delivery to the top lamella.

15. The method of claim 14, wherein the at least one switch includes a first switch coupled with the first portion and a second switch coupled with the second portion and each of the first switch and the second switch are coupled with the power supply.

16. A method of indicating a locked condition or an unlocked condition of a locking device through the use of a lock/unlock indicator, comprising:
providing the lock/unlock indicator with a lock indica and an unlock indica permanently displayed on the lock/unlock indicator; and
selectively displaying the lock indica and the unlock indica through lateral translation of the lock/unlock indicator to cause one of the lock indica and the unlock indica to be displayed through a window of the locking device.

17. The method of claim 16, wherein selectively displaying the lock indica and the unlock indica includes first receiving an actuation to place the locking device into the locked condition or the unlocked condition to cause the lateral translation of the lock/unlock indicator.
